(19) United States
(12) Patent Application Publication
(10) Pub. No.: US 2017/0291451 A1
(43) Pub. Date: Oct. 12, 2017

(54) Resin Composition and Pneumatic Tire Using Same

(71) Applicant: The Yokohama Rubber Co., LTD., Minata-ku, Tokyo (JP)

(72) Inventors: Yusuke Tanabe, Hiratsuka-shi, Kanagawa (JP); Shun Sato, Hiratsuka-shi, Kanagawa (JP)

(21) Appl. No.: 15/509,271

(22) PCT Filed: Sep. 9, 2015
(86) PCT No.: PCT/JP2015/075623

§ 371 Date: Mar. 7, 2017

(30) Foreign Application Priority Data
Sep. 9, 2014 (JP) 2014-183503

(51) Int. Cl. B60C 1/00; C08L 9/06; C08L 9/00; B60C 11/00

(52) U.S. Cl. CPC B60C 1/0016; B60C 11/0008; C08L 9/06; C08L 9/00; B60C 2011/0025; C08L 2205/035; C08L 2205/02

(57) ABSTRACT

Provided are a rubber composition containing from 1 to 30 parts by mass of an acid-modified polyolefin and from 0.3 to 20 parts by mass of at least one type selected from the group consisting of terpene resins and petroleum resins per 100 parts by mass of a diene rubber; and a pneumatic tire using the same.

### TECHNICAL FIELD

The present technology relates to a rubber composition and a pneumatic tire using the same.

### BACKGROUND ART

In recent years, there has been a demand for environmental consideration with regard to pneumatic tires from the perspective of protecting the global environment. For example, there is a demand to increase the level of vulcanization properties such as fuel efficiency performance.

On the other hand, there is also a demand for excellent processability of rubber compositions from the perspective of productivity.

The present applicant has proposed a rubber composition which has excellent processability at the time of unvulcanization, flexural fatigue resistance, and cut resistance and enables a reduction in weight, the rubber composition being produced by compounding from 1 to 50 parts by weight of a modified polymer, which is obtained by modifying a polyolefin resin with an unsaturated carboxylic acid, with 100 parts by weight of a diene rubber (see Japanese Unexamined Patent Application Publication No. H10-97900A).

As described above, there has recently been a demand for higher vulcanization properties in pneumatic tires. However, when a rubber composition is designed so as to have superior vulcanization properties, the processability of the rubber composition may be diminished.

### SUMMARY

The present technology provides: a rubber composition which has excellent processability while maintaining high vulcanization properties; and a pneumatic tire using the same.

As a result of conducting dedicated research, the present inventors discovered that a rubber composition containing from 1 to 30 parts by mass of an acid-modified polyolefin and from 0.3 to 20 parts by mass of at least one type selected from the group consisting of terpene resins and petroleum resins per 100 parts by mass of a diene rubber has excellent processability while maintaining high vulcanization properties, and the present inventors thereby completed the present technology.

Specifically, the inventors discovered the following features.

[1] A rubber composition containing from 1 to 30 parts by mass of an acid-modified polyolefin and from 0.3 to 20 parts by mass of at least one type selected from the group consisting of terpene resins and petroleum resins per 100 parts by mass of a diene rubber.

[2] The rubber composition according to [1], wherein the acid-modified polyolefin has a repeating unit formed from at least one type selected from the group consisting of ethylene and α-olefins.

[3] The rubber composition according to [2], wherein the α-olefin is at least one type selected from the group consisting of propylene, 1-butene, and 1-octene.

[4] The rubber composition according to any one of [1] to [3], wherein the acid-modified polyolefin is a polyolefin modified with maleic anhydride.

[5] The rubber composition according to any one of [1] to [4], wherein the terpene resin is an aromatic modified terpene resin having a softening point of not lower than 80° C.

[6] A pneumatic tire comprising the rubber composition according to any one of [1] to [5] in a structural member thereof.

[7] The pneumatic tire according to [6], wherein the structural member is a cap tread.

With the present technology, it is possible to obtain a rubber composition which has excellent processability while maintaining high vulcanization properties; and a pneumatic tire using the same.

### BRIEF DESCRIPTION OF DRAWINGS

FIG. 1 is a schematic partial cross-sectional view of a tire illustrating one example of an embodiment of a pneumatic tire of the present technology.

### DETAILED DESCRIPTION

The present technology is described in detail below.

### Rubber Composition

The rubber composition of the present technology (composition of the present technology) is:

a rubber composition containing from 1 to 30 parts by mass of an acid-modified polyolefin and from 0.3 to 20 parts by mass of at least one type selected from the group consisting of terpene resins and petroleum resins per 100 parts by mass of a diene rubber.

Note that in this specification, “at least one type selected from the group consisting of terpene resins and petroleum resins” may be described as “a terpene resin or the like” hereafter.

The composition of the present technology can achieve excellent processability while maintaining high vulcanization properties as a result of containing a prescribed amount of a terpene resin or the like with respect to a diene rubber and an acid-modified polyolefin.

Although the reason for this is unclear, it is presumed that not only does the acid-modified polyolefin interact with the diene rubber and a filler, but the terpene resin or the like also enhances the compatibility with the diene rubber and the acid-modified polyolefin, which yields a synergistic effect.

The components contained in the rubber composition of the present technology will now be described in detail.

### Diene Rubber

The diene rubber contained in the rubber composition of the present technology is not particularly limited as long as the diene rubber has double bonds in the main chain, and specific examples thereof include a natural rubber (NR), an isoprene rubber (IR), a butadiene rubber (BR), an aromatic vinyl/conjugated diene copolymer rubber, a chloroprene rubber (CR), an acrylonitrile butadiene rubber (NBR), an ethylene/propylene/diene copolymer rubber (EPDM), a styrene-isoprene rubber, an isoprene-butadiene rubber, a nitrile rubber, a hydrogenated nitrile rubber, and the like. One type of these may be used alone, or two or more types may be used in combination.

Of these, it is preferable to use an aromatic vinyl/conjugated diene copolymer rubber, NR, or BR from the perspective of achieving excellent wear resistance and superior processability.

Examples of the aromatic vinyl/conjugated diene copolymer rubber described above include a styrenebutadiene rubber (SBR), a styrene-isoprene rubber, a styrene-butadiene-isoprene rubber (SBIR), and the like. Of these, SBR is preferable.

The terminal of the aromatic vinyl/conjugated diene copolymer rubber may be modified with a hydroxy group, a polyorganosiloxane group, a carbonyl group, an amino group, or the like.

Furthermore, the weight average molecular weight of the aromatic vinyl/conjugated diene copolymer rubber is not particularly limited, but is preferably from 100000 to 2500000 and more preferably from 300000 to 2000000 from the perspective of processability. Note that the weight average molecular weight (Mw) of the aromatic vinyl/conjugated diene copolymer rubber is measured by gel permeation chromatography (GPC) on the basis of polystyrene standard using tetrahydrofuran as a solvent.

The aromatic vinyl/conjugated diene copolymer rubber preferably contains from 20 to 50 mass % of an aromatic vinyl, and more preferably contains from 20 to 70 mass % of the vinyl bond content in the conjugated diene, from the perspectives of processability and wear resistance.

When the diene rubber at least contains the aromatic vinyl/conjugated diene copolymer rubber, the amount of the aromatic vinyl/conjugated diene copolymer rubber contained in the diene rubber is preferably from 30 to 100 mass %, and more preferably from 40 to 90 mass %, from the perspective of enhancing low heat build-up and a balance of low heat build-up and wet grip performance.

### Acid-Modified Polyolefin

The acid-modified polyolefin contained in the rubber composition of the present technology is a polyolefin that is modified with carboxylic acid.

The backbone of the acid-modified polyolefin may be a homopolymer or a copolymer.

An example of a preferable aspect of the acid-modified polyolefin is one in which a repeating unit formed from at least one type selected from the group consisting of ethylene and α-olefins is contained.

Examples of the α-olefin include at least one type selected from the group consisting of propylene, 1-butene, and 1-octene.

### Polyolefin

Examples of the polyolefin constituting the backbone of the acid-modified polyolefin include: homopolymers such as polyethylene, polypropylene, polybutene, and polyoctene;

two-component copolymers such as ethylene/propylene copolymers, ethylene/1-butene copolymers, propylene/1-butene copolymers, propylene/1-hexene copolymers, propylene/4-methyl-1-pentene copolymers, propylene/1-octene copolymers, propylene/1-decene copolymers, propylene/1,4-hexadiene copolymers, propylene/dicyclopentadiene copolymers, propylene/5-ethylidene-2-norbornene copolymers, propylene/2,5-norbornadiene copolymers, propylene/5-ethylidene-2-norbornene copolymers, 1-octene/ethylene copolymers, 1-butene/propylene copolymers, 1-butene/1-hexene copolymers, 1-butene/4-methyl-1-pentene copolymers, 1-butene/1-octene copolymers, 1-butene/1-decene copolymers, 1-butene/1,4-hexadiene copolymers, 1-butene/dicyclopentadiene copolymers, 1-butene/5-ethylidene-2-norbornene copolymers, 1-butene/2,5-norbornadiene copolymers, and 1-butene/5-ethylidene-2-norbornene copolymers; and

multi-component copolymers such as ethylene/propylene/1-butene copolymers, ethylene/propylene/1-hexene copolymers, ethylene/propylene/1-octene copolymers, ethylene/propylene/1,4-hexadiene copolymers, ethylene/propylene/1,4-hexadiene copolymers, ethylene/propylene/dicyclopentadiene copolymers, ethylene/propylene/dicyclopentadiene copolymers, ethylene/propylene/5-ethylidene-2-norbornene copolymers, ethylene/propylene/5-ethylidene-2-norbornene copolymers, ethylene/propylene/2,5-norbornadiene copolymers, ethylene/propylene/2,5-norbornadiene copolymers, ethylene/propylene/5-ethylidene-2-norbornene copolymers, ethylene/propylene/5-ethylidene-2-norbornene copolymers, 1-butene/ethylene/propylene copolymers, 1-butene/ethylene/1-hexene copolymers, 1-butene/ethylene/1-octene copolymers, 1-butene/propylene/1-octene copolymers, 1-butene/ethylene/1,4-hexadiene copolymers, 1-butene/propylene/1,4-hexadiene copolymers, 1-butene/ethylene/dicyclopentadiene copolymers, 1-butene/propylene/dicyclopentadiene copolymers, 1-butene/ethylene/5-ethylidene-2-norbornene copolymers, 1-butene/propylene/5-ethylidene-2-norbornene copolymers, 1-butene/ethylene/2,5-norbornadiene copolymers, 1-butene/propylene/2,5-norbornadiene copolymers, 1-butene/ethylene/5-ethylidene-2-norbornene copolymers, and 1-butene/propylene/5-ethylidene-2-norbornene copolymers.

Of these, it is preferable to use polypropylene, polybutene, polyoctene, propylene/ethylene copolymers, 1-butene/ethylene copolymers, 1-butene/propylene copolymers, ethylene/propylene/1-butene copolymers, or 1-octene/ethylene copolymers.

### Carboxylic Acid

Meanwhile, examples of the carboxylic acid that modifies the polyolefin described above include an unsaturated carboxylic acid. Specific examples thereof include maleic acid, fumaric acid, acrylic acid, crotonic acid, methacrylic acid, itaconic acid, and acid anhydrides of each of these acids.

Of these, it is preferable to use maleic anhydride, maleic acid, or acrylic acid.

The modified polyolefin is preferably a polyolefin that is modified with maleic anhydride.

The acid-modified polyolefin may be produced, for example, with a method of graft-polymerizing an unsaturated carboxylic acid with the polyolefin described above by stirring while heating, and a commercially available product may also be used.

Examples of the commercially available product include maleic anhydride-modified propylene/ethylene copolymers, such as Tafmer MA8510 (manufactured by Mitsui Chemicals, Inc.) and MP0620 (manufactured by Mitsui Chemicals, Inc.); maleic anhydride-modified ethylene/1-butene copolymers, such as Tafmer MH7020 (manufactured by Mitsui Chemicals, Inc.); maleic anhydride-modified polypropylenes, such as Admer QE060 (manufactured by Mitsui Chemicals, Inc.); maleic anhydride-modified polyethylenes, such as Admer NF518 (manufactured by Mitsui Chemicals, Inc.); and the like.

The acid-modified polyolefin may be used alone, or two or more types thereof may be used in combination.

When the diene rubber contains the aromatic vinyl/conjugated diene copolymer rubber in a content of not less than 30 mass % of the diene rubber, the acid-modified polyolefin is preferably a maleic anhydride-modified ethylene/1-butene copolymer from the perspective of achieving low heat build-up and a balance between low heat build-up and wet grip performance.

When the diene rubber contains the aromatic vinyl/conjugated diene copolymer rubber in a content of less than 30 mass % of the diene rubber, the acid-modified polyolefin is preferably a maleic anhydride-modified polyethylene from the perspective of achieving low heat build-up and a balance between low heat build-up and wet grip performance.

In the present technology, the content of the acid-modified polyolefin is preferably from 2 to 25 parts by mass, more preferably from 3 to 20 parts by mass, and even more preferably from 5 to 15 parts by mass per 100 parts by mass of the diene rubber.

Furthermore, when the rubber composition of the present technology further contains silica, the content of the acid-modified polyolefin is preferably from 2 to 30 parts by mass, more preferably from 3 to 25 parts by mass, and even more preferably from 5 to 20 parts by mass per 100 parts by mass of the silica.

At least one type selected from the group consisting of terpene resins and petroleum resins

### Terpene Resin

Terpene resins that can be contained in the composition of the present technology are not particularly limited. Examples include unmodified terpene resins, aromatic modified terpene resins, phenol modified terpene resins, and hydrogenated terpene resins obtained by hydrogenating these terpene resins.

Of these, aromatic modified terpene resins are preferable from the perspective of achieving superior processability and excellent wet grip performance.

In addition, the softening point of the terpene resin is preferably not lower than 80° C. and more preferably from 85 to 130° C. from the perspective of achieving superior processability and excellent wet grip performance.

The terpene resin is preferably an aromatic modified terpene resin having a softening point of not lower than 80° C. due to the same reasons as those described above.

The softening point of the terpene resin was measured in accordance with JIS (Japanese Industrial Standard) K 6220-1.

A method for producing the terpene resin is not particularly limited. In addition, the terpene resin may be a commercially available product, and examples of commercially available product of terpene resin include YS Resin PX 300, YS Resin PX 300N, Daimaron, and YS Polyster T30 manufactured by Yasuhara Chemical Co., Ltd.

The terpene resin may be used alone, or two or more types may be used in combination.

### Petroleum Resin

Petroleum resins that can be contained in the composition of the present technology are not particularly limited. Examples include aliphatic hydrocarbon resins (C₅-based petroleum resins), aromatic hydrocarbon resins (C₉-based petroleum resins), and copolymer resins of aliphatic hydrocarbons and aromatic hydrocarbons (C₅C₉ copolymer petroleum resins).

Of these, aliphatic hydrocarbon resins are preferable from the perspective of achieving superior processability and excellent wet grip performance.

An aliphatic hydrocarbon resin may be a resin produced using an aliphatic monomer including 1,3-pentadiene extracted from a C₅ fraction obtained by naphtha cracking, for example.

The softening point of the petroleum resin is preferably not lower than 80° C. and more preferably from 85 to 130° C. from the perspective of achieving superior processability and excellent wet grip performance.

The softening point of the petroleum resin was measured in accordance with JIS K 2207 (ring and ball method).

A method for producing the petroleum resin is not particularly limited. In addition, the petroleum resin may be a commercially available product, and an example of the commercially available product of the petroleum resin include Quintone A100 manufactured by the Zeon Corporation.

The petroleum resin may be used alone, or two or more types may be used in combination.

In the present technology, the content of the at least one type selected from the group consisting of terpene resins and petroleum resins is from 0.3 to 20 parts by mass, preferably from 0.5 to 15 parts by mass, and more preferably from 1 to 12 parts by mass per 100 parts by mass of the diene rubber. Note that when the composition of the present technology contains the terpene resin and the petroleum resin, the content described above refers to the total content of the terpene resin and the petroleum resin.

In the present technology, the amount of the terpene resin is preferably from 0.5 to 15 parts by mass and more preferably from 1 to 12 parts by mass per 100 parts by mass of the diene rubber from the perspective of achieving superior processability and excellent wet grip performance.

In addition, the amount of the terpene resin is preferably from 0.3 to 5 parts by mass, more preferably from 0.5 to 4 parts by mass, and even more preferably from 0.5 to 0.8 parts by mass per 100 parts by mass of the diene rubber from the perspective of achieving excellent low heat build-up.

In the present technology, the amount of the petroleum resin is preferably from 0.5 to 15 parts by mass and more preferably from 1 to 12 parts by mass per 100 parts by mass of the diene rubber from the perspective of achieving superior processability.

In addition, the amount of the petroleum resin is preferably from 0.3 to 5 parts by mass and more preferably from 0.5 to 4 parts by mass per 100 parts by mass of the diene rubber from the perspective of achieving excellent low heat build-up.

### Silica

The rubber composition of the present technology preferably further contains silica. The silica is not particularly limited, and any conventionally known silica that is blended in rubber compositions for use in tires or the like can be used.

Specific examples of the silica include fumed silica, calcined silica, precipitated silica, pulverized silica, molten silica, and colloidal silica. One type of these may be used alone, or two or more types may be used in combination.

Furthermore, the CTAB (cetyl trimethyl ammonium bromide) adsorption specific surface area of the silica is preferably from 50 to 300 m²/g, and more preferably from 80 to 250 m²/g, from the perspective of suppressing aggregation of the silica.

Note that the CTAB adsorption specific surface area is a value of the amount of n-hexadecyltrimethylammonium bromide adsorbed to the surface of silica measured in accordance with JIS K6217-3:2001 “Part 3: Method for determining specific surface area—CTAB adsorption method.”

In the present technology, the content of the silica is preferably from 5 to 150 parts by mass, more preferably from 10 to 120 parts by mass, and even more preferably from 20 to 100 parts by mass, per 100 parts by mass of the diene rubber.

### Silane Coupling Agent

The rubber composition of the present technology preferably further contains a silane coupling agent. The silane coupling agent is not particularly limited, and any conventionally known silane coupling agent that is blended in rubber compositions for use in tires or the like can be used.

Specific examples of the silane coupling agent include bis(3-triethoxysilylpropyl)tetrasulfide, bis(3-triethoxysilylpropyl)trisulfide, bis(3-triethoxysilylpropyl)disulfide, bis(2-triethoxysilylethyl)tetrasulfide, bis(3-trimethoxysilylpropyl)tetrasulfide, bis(2-trimethoxysilylethyl)tetrasulfide, 3-mercaptopropyltrimethoxysilane, 3-mercaptopropyltriethoxysilane, 2-mercaptoethyltrimethoxysilane, 2-mercaptoethyltriethoxysilane, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilylethyl-N,N-dimethylthiocarbamoyl tetrasulfide, 3-trimethoxysilylpropyl benzothiazole tetrasulfide, 3-triethoxysilylpropyl benzothiazole tetrasulfide, 3-triethoxysilylpropyl methacrylate monosulfide, 3-trimethoxysilylpropyl methacrylate monosulfide, bis(3-diethoxymethylsilylpropyl)tetrasulfide, dimethoxymethylsilylpropyl-N,N-dimethylthiocarbamoyl tetrasulfide, dimethoxymethylsilylpropyl benzothiazole tetrasulfide, and the like. One type of these may be used alone, or two or more types may be used in combination. In addition, one or two or more types of these may be oligomerized in advanced and used.

Furthermore, specific examples of the silane coupling agent other than those listed above include mercapto-based silane coupling agents such as γ-mercaptopropyltriethoxysilane and 3-[ethoxybis(3,6,9,12,15-pentaoxaoctacosane-1-yloxy)silyl]-1-propanethiol; thiocarboxylate-based silane coupling agents such as 3-octanoylthiopropyltriethoxysilane; and thiocyanate-based silane coupling agents such as 3-thiocyanatepropyltriethoxysilane. One type of these may be used alone, or two or more types may be used in combination. In addition, one or two or more types of these may be oligomerized in advanced and used.

Of these examples, to improve the reinforcing properties of the tire, bis(3-triethoxysilylpropyl)tetrasulfide and/or bis(3-triethoxysilylpropyl)disulfide is preferably used. Specific examples thereof include Si69 (bis(3-triethoxysilylpropyl)tetrasulfide, manufactured by Evonik Degussa), Si75 (bis(3-triethoxysilylpropyl)disulfide, manufactured by Evonik Degussa), and the like.

The content of the silane coupling agent is preferably not less than 1 part by mass, and more preferably from 1 to 10 parts by mass, per 100 parts by mass of the diene rubber.

Furthermore, the content of the silane coupling agent is preferably from 0.1 to 20 parts by mass, and more preferably from 0.5 to 15 parts by mass, per 100 parts by mass of the silica.

### Carbon Black

The rubber composition of the present technology preferably further contains carbon black.

Specific examples of the carbon black include furnace carbon blacks such as SAF (super abrasion furnace), ISAF (intermediate abrasion furnace), HAF (high abrasion furnace), FEF (fast extruding furnace), GPE (general purpose furnace), and SRF (semi-reinforcing furnace), and one type of these can be used alone, or two or more types can be used in combination.

Moreover, the carbon black is preferably one having a nitrogen specific surface area (N₂SA) of from 10 to 300 m²/g and more preferably from 20 to 200 m²/g from the perspective of processability when the rubber composition is mixed. Note that the N₂SA is a value of the amount of nitrogen adsorbed to the surface of carbon black, measured in accordance with JIS K6217-2:2001, “Part 2: Determination of specific surface area—Nitrogen adsorption methods—Single-point procedures.”

The content of the carbon black is preferably from 1 to 100 parts by mass, and more preferably from 5 to 80 parts by mass, per 100 parts by mass of the diene rubber.

### Other Components

The rubber composition of the present technology may contain, in addition to the components described above, additives that are typically used in rubber compositions for tires including: a resin other than terpene resins and petroleum resins; a filler such as calcium carbonate; a chemical foaming agent such as a hollow polymer; a vulcanizing agent such as sulfur; a sulfenamide-based, guanidine-based, thiazole-based, thiourea-based, or thiuram-based vulcanization accelerator; a vulcanization accelerator aid such as zinc oxide and stearic acid; wax; oil; an amine-based anti-aging agent such as paraphenylene diamines (e.g. N,N′-di-2-naphthyl-p-phenylenediamine, N-1,3-dimethylbutyl-N′-phenyl-p-phenylenediamine, or the like), and ketone-amine condensates (e.g. 2,2,4-trimethyl-1,2-dihydroquinoline or the like); a plasticizer; and the like.

The compounded amount of these additives may be any conventional amount, as long as the object of the present technology is not impaired. For example, the compounded amounts per 100 parts by mass of the diene rubber may be:

sulfur: from 0.5 to 5 parts by mass,

vulcanization accelerator: from 0.1 to 5 parts by mass,

vulcanization accelerator aid: from 0.1 to 10 parts by mass,

anti-aging agent: from 0.5 to 5 parts by mass,

wax: from 1 to 10 parts by mass, and

oil: from 5 to 30 parts by mass.

### Method for Producing Rubber Composition

method for producing the rubber composition of the present technology is not particularly limited, and an example thereof include a method of kneading the above-mentioned components using a publicly known method and device (such as a Banbury mixer, kneader, or roll).

In addition, the rubber composition of the present technology can be vulcanized or crosslinked under conventionally known vulcanizing or crosslinking conditions.

### Pneumatic Tire

A pneumatic tire of the present technology (also simply called the “tire of the present technology” hereafter) is a pneumatic tire including the rubber composition of the present technology described above in a structural (rubber) member thereof.

Here, the structural member including the rubber composition of the present technology is not particularly limited, but examples include a tire tread portion, a sidewall portion, a bead portion, a member for covering a belt layer, a member for covering a carcass layer, an inner liner, and the like. Of these, a tire tread portion is preferable.

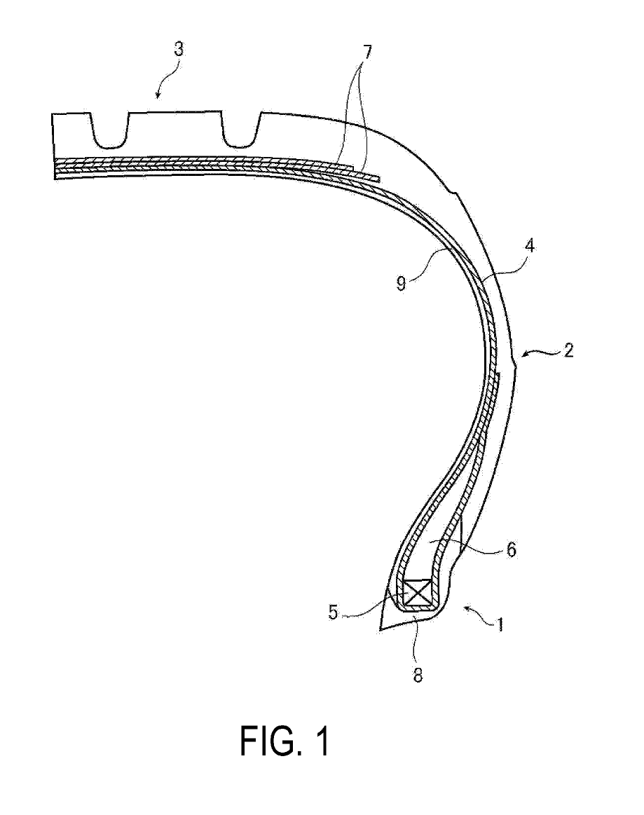

FIG. 1 is a schematic partial cross-sectional view of a tire illustrating one embodiment of the tire of the present technology, but the tire of the present technology is not limited to the embodiment illustrated in FIG. 1.

In FIG. 1, reference sign 1 indicates a bead portion, reference sign 2 indicates a sidewall portion, and reference sign 3 indicates a tire tread portion.

In addition, a carcass layer 4, in which a fiber cord is embedded, is mounted between a left-right pair of bead portions 1, and ends of the carcass layer 4 are wound by being folded around bead cores 5 and a bead filler 6 from an inner side to an outer side of the tire.

In the tire tread portion 3, a belt layer 7 is provided along the entire circumference of the tire on the outer side of the carcass layer 4.

Additionally, rim cushions 8 are provided in parts of the bead portions 1 that are in contact with a rim.

In addition, an inner liner 9 is provided on the inside surface of the pneumatic tire in order to prevent the air filling the inside of the tire from leaking to the outside of the tire.

When the rubber composition of the present technology is used in a cap tread of a tire tread portion in the tire of the present technology, for example, the tire has excellent low heat build-up, high-temperature extension, wet grip performance, and wear resistance.

In addition, the tire of the present technology can be produced by forming the structural member (for example, cap tread) by vulcanization or crosslinking using the rubber composition described above at a temperature corresponding to the type and compounding ratio of the diene rubber, vulcanizing agent or crosslinking agent, and vulcanization or crosslinking accelerator used in the rubber composition of the present technology.

### Examples

The present technology is described below in detail using Examples. However, the present technology is not limited to such Examples.

### Production of Composition

Components shown in each of the following tables were blended at the proportions (parts by mass) shown in the tables.

Specifically, the components shown in each table except for vulcanization components (sulfur and vulcanization accelerators) were kneaded in a 1.7 L sealed mixer for 5 minutes, and the mixture was discharged outside the mixer when the temperature reached 150° C., to be cooled at room temperature. Thereafter, the mixture and the vulcanization components were kneaded using an open roll to produce a rubber composition.

### Mooney Viscosity

The Mooney viscosity of the rubber composition (unvulcanized) produced as described above was measured under conditions including a preheating time of 1 minute, a rotor rotation time of 4 minutes, and a test temperature of 100° C. using an L-shaped rotor in accordance with JIS K6300-1:2013. The measurement results are shown using the value of Comparative Example 1 as an index of 100 in Tables 1 and 3 and using the value of Comparative Example 7 as an index of 100 in Table 2.

A smaller index indicates a lower viscosity and thus indicates superior processability.

### Production of Vulcanized Rubber Sheet

A vulcanized rubber sheet was produced by vulcanizing the rubber composition that was produced as described above for 20 minutes at 160° C. in a mold for Lambourn abrasion (disk having a diameter of 63.5 mm and a thickness of 5 mm).

The following vulcanization properties were evaluated using the vulcanized rubber sheet produced as described above. The results are shown in each table below. The measurement results are shown using the value of Comparative Example 1 as an index of 100 in Tables 1 and 3 and using the value of Comparative Example 7 as an index of 100 in Table 2.

### Hardness

For the vulcanized rubber sheet that was produced as described above, the durometer hardness (type A) was measured and evaluated at 20° C. in accordance with JIS K6253-3:2012.

A larger index indicates superior hardness.

### Tensile Stress at a Given Elongation (Sₑ): (Indicator of Modulus)

From the vulcanized rubber sheet produced as described above, a JIS No. 3 dumbbell-shaped test piece was punched out, and a tensile test was performed at a tensile rate of 500 mm/min in accordance with JIS K6251:2010 to measure the tensile stress at 100% elongation (100% modulus; hereinafter, abbreviated as “M100”) and the tensile stress at 300% elongation (300% modulus; hereinafter, abbreviated as “M300”) under conditions at room temperature.

A larger index indicates greater stress and a higher modulus.

### Elongation at Break (E_{B}): (Indicator of Breaking Elongation)

A JIS No. 3 dumbbell-shaped test piece was punched out from the vulcanized rubber sheets produced as described above, and a tensile test was performed in accordance with JIS K6251:2010 at a tensile rate of 500 mm/minute. The elongation at break (E_{B}) was measured under conditions at room temperature.

A larger index indicates superior breaking elongation.

Impact Resilience (60° C.) The impact resilience of the vulcanized rubber sheet produced as described above at a temperature of 60° C. was measured in accordance with JIS K6255:2013.

A larger index indicates superior impact resilience.

### tan δ (60° C.)

The value of the loss tangent tan δ (60° C.) was measured for the vulcanized rubber sheet produced as described above under conditions including an elongation deformation distortion of 10±2%, an oscillation frequency of 20 Hz, and a temperature of 60° C. using a viscoelastic spectrometer (manufactured by Iwamoto Manufacturing).

A smaller index indicates superior low heat build-up.

TABLE 1

| | Compar- | Compar- | Compar- | Compar- |
|---|---|---|---|---|
| | ative | ative | ative | ative |
| | Exam- | Exam- | Exam- | Exam- |
| | ple 1 | ple 2 | ple 3 | ple 4 |
| E-SBR | 80 | 80 | 80 | 80 |
| BR | 20 | 20 | 20 | 20 |
| Acid-modified | | | 10 | 10 |
| polyolefin 1 | | | | |
| Silane coupling | 4 | 4 | 4 | 4 |
| agent | | | | |
| Silica | 75 | 75 | 75 | 75 |
| Terpene resin | | 10 | | 0.1 |
| Carbon black | 5 | 5 | 5 | 5 |
| Zinc oxide | 3 | 3 | 3 | 3 |
| Stearic acid | 1 | 1 | 1 | 1 |
| Anti-aging agent | 1 | 1 | 1 | 1 |
| Oil | 6 | 6 | 6 | 6 |
| Sulfur | 2 | 2 | 2 | 2 |
| Sulfur-containing | 1 | 1 | 1 | 1 |
| vulcanization | | | | |
| accelerator (CZ) | | | | |
| Vulcanization | 0.5 | 0.5 | 0.5 | 0.5 |
| accelerator (DPG) | | | | |

Processability

| | | | | |
|---|---|---|---|---|
| Mooney viscosity | 100 | 85 | 109 | 107 |

Vulcanization properties

| | | | | |
|---|---|---|---|---|
| Hardness (20° C.) | 100 | 94 | 105 | 104 |
| M100 | 100 | 92 | 103 | 103 |
| M300 | 100 | 92 | 102 | 101 |
| EB (elongation | 100 | 111 | 109 | 107 |
| at break) | | | | |
| Impact resilience | 100 | 94 | 107 | 105 |
| (60° C.) | | | | |
| Tanδ(60° C.) | 100 | 105 | 88 | 89 |

| | | | | Compar- | Compar- |
|---|---|---|---|---|---|
| | | | | ative | ative |
| | Exam- | Exam- | Exam- | Exam- | Exam- |
| | ple 1 | ple 2 | ple 3 | ple 5 | ple 6 |
| E-SBR | 80 | 80 | 80 | 80 | 80 |
| BR | 20 | 20 | 20 | 20 | 20 |
| Acid-modified | 10 | 10 | 10 | 10 | 10 |
| polyolefin 1 | | | | | |
| Silane coupling | 4 | 4 | 4 | 4 | 4 |
| agent | | | | | |
| Silica | 75 | 75 | 75 | 75 | 75 |
| Terpene resin | 0.5 | 3 | 10 | 30 | |
| Carbon black | 5 | 5 | 5 | 5 | 5 |
| Zinc oxide | 3 | 3 | 3 | 3 | 3 |
| Stearic acid | 1 | 1 | 1 | 1 | 1 |
| Anti-aging agent | 1 | 1 | 1 | 1 | 1 |
| Oil | 6 | 6 | 6 | 6 | 16 |
| Sulfur | 2 | 2 | 2 | 2 | 2 |
| Sulfur-containing | 1 | 1 | 1 | 1 | 1 |
| vulcanization | | | | | |
| accelerator (CZ) | | | | | |
| Vulcanization | 0.5 | 0.5 | 0.5 | 0.5 | 0.5 |
| accelerator (DPG) | | | | | |

Processability

| | | | | | |
|---|---|---|---|---|---|
| Mooney viscosity | 98 | 96 | 92 | 87 | 94 |

Vulcanization properties

| | | | | | |
|---|---|---|---|---|---|
| Hardness (20° C.) | 104 | 104 | 104 | 101 | 95 |
| M100 | 103 | 102 | 101 | 96 | 95 |
| M300 | 102 | 103 | 102 | 94 | 91 |
| EB (elongation | 111 | 113 | 117 | 125 | 105 |
| at break) | | | | | |
| Impact resilience | 106 | 104 | 104 | 100 | 94 |
| (60° C.) | | | | | |
| Tanδ(60° C.) | 87 | 88 | 90 | 102 | 104 |

TABLE 2

| | Compar- | Compar- | Compar- | Compar- |
|---|---|---|---|---|
| | ative | ative | ative | ative |
| | Exam- | Exam- | Exam- | Exam- |
| | ple 7 | ple 8 | ple 9 | ple 10 |
| E-SBR | 20 | 20 | 20 | 20 |
| BR | 80 | 80 | 80 | 80 |
| Acid-modified | | | 10 | 10 |
| polyolefin 2 | | | | |
| Silane coupling | 4 | 4 | 4 | 4 |
| agent | | | | |
| Silica | 75 | 75 | 75 | 75 |
| Terpene resin | | 10 | | 0.1 |
| Carbon black | 5 | 5 | 5 | 5 |
| Zinc oxide | 3 | 3 | 3 | 3 |
| Stearic acid | 1 | 1 | 1 | 1 |
| Anti-aging agent | 1 | 1 | 1 | 1 |
| Oil | 6 | 6 | 6 | 6 |
| Sulfur | 2 | 2 | 2 | 2 |
| Sulfur-containing | 1 | 1 | 1 | 1 |
| vulcanization | | | | |
| accelerator (CZ) | | | | |
| Vulcanization | 0.5 | 0.5 | 0.5 | 0.5 |
| accelerator (DPG) | | | | |

Processability

| | | | | |
|---|---|---|---|---|
| Mooney viscosity | 100 | 92 | 115 | 112 |

Vulcanization properties

| | | | | |
|---|---|---|---|---|
| Hardness (20° C.) | 100 | 95 | 108 | 108 |
| M100 | 100 | 93 | 109 | 108 |
| M300 | 100 | 90 | 106 | 105 |
| EB (elongation | 100 | 104 | 109 | 111 |
| at break) | | | | |
| Impact resilience | 100 | 95 | 106 | 105 |
| (60° C.) | | | | |
| Tanδ(60° C.) | 100 | 104 | 82 | 85 |

| | | | | Compar- | Compar- |
|---|---|---|---|---|---|
| | | | | ative | ative |
| | Exam- | Exam- | Exam- | Exam- | Exam- |
| | ple 4 | ple 5 | ple 6 | ple 11 | ple 12 |
| E-SBR | 20 | 20 | 20 | 20 | 20 |
| BR | 80 | 80 | 80 | 80 | 80 |
| Acid-modified | 10 | 10 | 10 | 10 | 10 |
| polyolefin 2 | | | | | |
| Silane coupling | 4 | 4 | 4 | 4 | 4 |
| agent | | | | | |
| Silica | 75 | 75 | 75 | 75 | 75 |
| Terpene resin | 0.5 | 3 | 10 | 30 | |
| Carbon black | 5 | 5 | 5 | 5 | 5 |
| Zinc oxide | 3 | 3 | 3 | 3 | 3 |
| Stearic acid | 1 | 1 | 1 | 1 | 1 |
| Anti-aging agent | 1 | 1 | 1 | 1 | 1 |
| Oil | 6 | 6 | 6 | 6 | 16 |
| Sulfur | 2 | 2 | 2 | 2 | 2 |
| Sulfur-containing | 1 | 1 | 1 | 1 | 1 |
| vulcanization | | | | | |
| accelerator (CZ) | | | | | |
| Vulcanization | 0.5 | 0.5 | 0.5 | 0.5 | 0.5 |
| accelerator (DPG) | | | | | |

Processability

| | | | | | |
|---|---|---|---|---|---|
| Mooney viscosity | 99 | 95 | 91 | 85 | 94 |

Vulcanization properties

| | | | | | |
|---|---|---|---|---|---|
| Hardness (20° C.) | 107 | 105 | 103 | 100 | 94 |
| M100 | 106 | 105 | 102 | 97 | 96 |
| M300 | 105 | 104 | 102 | 93 | 92 |
| EB (elongation | 114 | 118 | 125 | 120 | 107 |
| at break) | | | | | |
| Impact resilience | 106 | 105 | 104 | 100 | 93 |
| (60° C.) | | | | | |
| Tanδ(60° C.) | 84 | 85 | 88 | 92 | 103 |

TABLE 3

| | Compar- | Compar- | Compar- | Compar- |
|---|---|---|---|---|
| | ative | ative | ative | ative |
| | Exam- | Exam- | Exam- | Exam- |
| | ple 1 | ple 13 | ple 3 | ple 14 |
| E-SBR | 80 | 80 | 80 | 80 |
| BR | 20 | 20 | 20 | 20 |
| Acid-modified | | | 10 | 10 |
| polyolefin 1 | | | | |
| Silane coupling | 4 | 4 | 4 | 4 |
| agent | | | | |
| Silica | 75 | 75 | 75 | 75 |
| Petroleum resin | | 10 | | 0.1 |
| Carbon black | 5 | 5 | 5 | 5 |
| Zinc oxide | 3 | 3 | 3 | 3 |
| Stearic acid | 1 | 1 | 1 | 1 |
| Anti-aging agent | 1 | 1 | 1 | 1 |
| Oil | 6 | 6 | 6 | 6 |
| Sulfur | 2 | 2 | 2 | 2 |
| Sulfur-containing | 1 | 1 | 1 | 1 |
| vulcanization | | | | |
| accelerator (CZ) | | | | |
| Vulcanization | 0.5 | 0.5 | 0.5 | 0.5 |
| accelerator (DPG) | | | | |

Processability

| | | | | |
|---|---|---|---|---|
| Mooney viscosity | 100 | 87 | 109 | 108 |

Vulcanization properties

| | | | | |
|---|---|---|---|---|
| Hardness (20° C.) | 100 | 107 | 105 | 104 |
| M100 | 100 | 111 | 103 | 103 |
| M300 | 100 | 93 | 102 | 101 |
| EB (elongation | 100 | 111 | 109 | 107 |
| at break) | | | | |
| Impact resilience | 100 | 93 | 107 | 105 |
| (60° C.) | | | | |
| Tanδ(60° C.) | 100 | 105 | 88 | 89 |

| | | | Compar- | Compar- |
|---|---|---|---|---|
| | | | ative | ative |
| | Exam- | Exam- | Exam- | Exam- |
| | ple 7 | ple 8 | ple 15 | ple 6 |
| E-SBR | 80 | 80 | 80 | 80 |
| BR | 20 | 20 | 20 | 20 |
| Acid-modified | 10 | 10 | 10 | 10 |
| polyolefin 1 | | | | |
| Silane coupling | 4 | 4 | 4 | 4 |
| agent | | | | |
| Silica | 75 | 75 | 75 | 75 |
| Petroleum resin | 3 | 10 | 30 | |
| Carbon black | 5 | 5 | 5 | 5 |
| Zinc oxide | 3 | 3 | 3 | 3 |
| Stearic acid | 1 | 1 | 1 | 1 |
| Anti-aging agent | 1 | 1 | 1 | 1 |
| Oil | 6 | 6 | 6 | 16 |
| Sulfur | 2 | 2 | 2 | 2 |
| Sulfur-containing | 1 | 1 | 1 | 1 |
| vulcanization | | | | |
| accelerator (CZ) | | | | |
| Vulcanization | 0.5 | 0.5 | 0.5 | 0.5 |
| accelerator (DPG) | | | | |

Processability

| | | | | |
|---|---|---|---|---|
| Mooney viscosity | 99 | 94 | 103 | 94 |

Vulcanization properties

| | | | | |
|---|---|---|---|---|
| Hardness (20° C.) | 105 | 107 | 118 | 95 |
| M100 | 105 | 106 | 99 | 95 |
| M300 | 103 | 101 | 90 | 91 |
| EB (elongation | 110 | 113 | 120 | 105 |
| at break) | | | | |
| Impact resilience | 103 | 107 | 107 | 94 |
| (60° C.) | | | | |
| Tanδ(60° C.) | 90 | 98 | 105 | 104 |

The details of each component shown in each of the above tables are as follows.
E-SBR: emulsion polymerized SBR, Nipol 1502 (manufactured by Zeon Corporation)
BR: Nipol BR 1220 (manufactured by Zeon Corporation)
Acid-modified polyolefin 1: maleic anhydride-modified ethylene/1-butene copolymer (Tafmer MH7020, manufactured by Mitsui Chemicals, Inc.)
Acid-modified polyolefin 2: maleic anhydride-modified polyethylene (Admer NF518, manufactured by Mitsui Chemicals, Inc.)
Silane coupling agent: sulfide-based silane coupling agent; Si69VP (manufactured by Evonik Degussa)
Silica: wet silica (Nipsil AQ, CTAB adsorption specific surface area: 170 m²/g; manufactured by Japan Silica Corporation)
Terpene resin: aromatic modified terpene resin; YS Resin TO-125, manufactured by Yasuhara Chemical Co., Ltd.; softening point: 125° C.
Petroleum resin: aliphatic hydrocarbon resin, Quintone A100, manufactured by the Zeon Corporation, softening point: 100° C.
Carbon black: Show Black N339M (manufactured by Showa Cabot K.K.)
Zinc oxide: Zinc oxide III (manufactured by Seido Chemical Industry Co., Ltd.)
Stearic acid: stearic acid beads (manufactured by Nippon Oil & Fats Co., Ltd.)
Anti-aging agent: N-(1,3-dimethylbutyl)-N′-phenyl-p-phenylenediamine (Antigen 6C, manufactured by Sumitomo Chemical Co., Ltd.)
Oil: Extract No. 4 S (manufactured by Showa Shell Sekiyu K.K.)
Sulfur: oil treatment sulfur (manufactured by Karuizawa Refinery Ltd.)
Sulfur-containing vulcanization accelerator (CZ): N-cyclohexyl-2-benzothiazolesulfenamide (Sanceller CM-PO, manufactured by Sanshin Chemical Industry Co., Ltd.)
Vulcanization accelerator (DPG): 1,3-diphenylguanidine (Sanceller manufactured by Sanshin Chemical Industry Co., Ltd.)

As is clear from the results shown in Table 1, Comparative Example 3, which does not contain a terpene resin or the like, demonstrated lower processability than Comparative Example 1, which does not contain an acid-modified polyolefin and a terpene resin or the like.

Comparative Example 2, which does not contain an acid-modified polyolefin, had at least one vulcanization property that was lower than in Comparative Example 1.

Comparative Example 4, in which the amount of the terpene resin is less than a prescribed amount, exhibited lower processability than Comparative Example 1.

Comparative Example 5, in which the amount of the terpene resin is greater than a prescribed amount, had at least one vulcanization property that was lower than in Comparative Example 1.

Comparative Example 6, which has a greater amount of oil and does not contain a terpene resin or the like, had at least one vulcanization property that was lower than in Comparative Example 1.

In contrast, Examples 1 to 3 exhibited processability superior to that of Comparative Example 1 while maintaining high vulcanization properties.

As is clear from the results shown in Table 2, Comparative Example 9, which does not contain a terpene resin or the like, demonstrated lower processability than Comparative Example 7, which does not contain an acid-modified polyolefin and a terpene resin or the like.

Comparative Example 8, which does not contain an acid-modified polyolefin, had at least one vulcanization property that was lower than in Comparative Example 7.

Comparative Example 10, in which the amount of the terpene resin is less than a prescribed amount, exhibited lower processability than Comparative Example 7.

Comparative Example 11, in which the amount of the terpene resin is greater than a prescribed amount, had at least one vulcanization property that was lower than in Comparative Example 7.

Comparative Example 12, which has a greater amount of oil and does not contain a terpene resin or the like, had at least one vulcanization property that was lower than in Comparative Example 7.

In contrast, Examples 4 to 6 exhibited processability superior to that of Comparative Example 7 while maintaining high vulcanization properties.

As is clear from the results shown in Table 3, Comparative Example 3, which does not contain a terpene resin or the like (petroleum resin), demonstrated lower processability than Comparative Example 1, which does not contain an acid-modified polyolefin and a terpene resin or the like (petroleum resin).

Comparative Example 13, which does not contain an acid-modified polyolefin, had at least one vulcanization property that was lower than in Comparative Example 1.

Comparative Example 14, in which the amount of the petroleum resin is less than a prescribed amount, exhibited lower processability than Comparative Example 1.

Comparative Example 15, in which the amount of the petroleum resin is greater than a prescribed amount, demonstrated lower processability and had at least one vulcanization property that was lower than in Comparative Example 1.

Comparative Example 6, which has a greater amount of oil and does not contain a terpene resin or the like (petroleum resin), had at least one vulcanization property that was lower than in Comparative Example 1.

In contrast, Examples 7 and 8 exhibited processability superior to that of Comparative Example 1 while maintaining high vulcanization properties.

In this way, in the present technology, the terpene resin or the like does not inhibit the high vulcanization properties imparted by the acid-modified polyolefin.

In addition, a smaller amount of the terpene resin or the like yields superior low heat build-up.

Specifically, from a comparison of Example 1 with Examples 2 and 3, the low heat build-up is superior when the amount of the terpene resin is from 0.3 to 5 parts by mass (or from 0.3 to 2 parts by mass) per 100 parts by mass of the diene rubber. The same can be said in a comparison of Example 4 with Examples 5 and 6.

From a comparison of Examples 7 and 8, the low heat build-up is superior when the amount of the petroleum resin is not greater than 5 parts by mass per 100 parts by mass of the diene rubber.

1. A rubber composition containing from 1 to 30 parts by mass of an acid-modified polyolefin and from 0.3 to 20 parts by mass of at least one type selected from the group consisting of terpene resins and petroleum resins per 100 parts by mass of a diene rubber.

2. The rubber composition according to claim 1, wherein the acid-modified polyolefin has a repeating unit formed from at least one type selected from the group consisting of ethylene and α-olefins.

3. The rubber composition according to claim 2, wherein the α-olefin is at least one type selected from the group consisting of propylene, 1-butene, and 1-octene.

4. The rubber composition according to claim 1, wherein the acid-modified polyolefin is a polyolefin modified with maleic anhydride.

5. The rubber composition according to claim 1, wherein the terpene resin is an aromatic modified terpene resin having a softening point of not lower than 80° C.

6. A pneumatic tire comprising the rubber composition according to claim 1 in a structural member thereof.

7. The pneumatic tire according to claim 6, wherein the structural member is a cap tread.
